(19) United States
(12) Patent Application Publication
(10) Pub. No.: US 2019/0226963 A1
(43) Pub. Date: Jul. 25, 2019

(54) CALIBRATION OF NUCLEAR DENSITY METERS

(71) Applicant: SYNCRUDE CANADA LTD. in trust for the owners of the Syncrude Project as such owners exist now and, Fort McMurray (CA)

(72) Inventors: WAYNE JANSEN, Edmonton (CA); PATRICK DOUGAN, Kelowna (CA); TREVOR HOUTSTRA, Edmonton (CA); GARY ANTHIEREN, Spruce Grove (CA)

(21) Appl. No.: 15/875,824

(22) Filed: Jan. 19, 2018

(51) Int. Cl. G01N 9/24; G01N 23/06

(52) U.S. Cl. CPC G01N 9/24; G01N 23/06

(57) ABSTRACT

A method of calibrating a nuclear density meter used in the measurement of density of a sand/water/oil slurry flowing in a pipe, without sampling the slurry, is provided comprising determining a net attenuation coefficient for the slurry being measured and mitigating radiation buildup.

### FIELD OF THE INVENTION

This invention relates to systems and methods of calibrating nuclear density meters.

### BACKGROUND

Nuclear density meters or gauges are used in the bitumen processing industry to measure the density of process fluids. Such gauges are well known and are known to be efficient, non-intrusive and safe instruments. Their basic principle of operation is based on attenuation of a narrow beam of gamma photons emitted by a radioactive nuclide through a process pipeline. The degree of attenuation is measured by a detector, and is correlated to the density and composition of the process fluid they pass through, and the distance travelled. Assuming a pipeline inside diameter is constant, measurement of the transmitted radiation intensity is inversely proportional to the absorber density, and is dependent on the absorption coefficient of the process fluid.

Accurate readings depend on accurate calibration of the gauges. Calibration requires the use of standard samples having known properties, however, representative and repeatable samples are difficult to obtain with large slurry pipelines which transport large particles and/or non-homogenous materials.

Therefore, there remains a need in the art for methods and systems of more accurately calibrating nuclear density gauges used in large-scale mining operations.

### SUMMARY OF THE INVENTION

The invention comprises a calibration method that may be used to calibrate nuclear density meters without the need for sample verification. The method may be performed online and is based on first principles, eliminating the need to use representative stream contents as the calibration standard.

In any nuclear density meter, the amount of gamma radiation that reaches a detector can be predicted as it follows the Lambert/Beers absorption law. However, there are negative factors that will skew the prediction. In embodiments of this invention, the extent of those negative factors are determined and then the calibration curve is compensated to reduce, eliminate or mitigate them. The two main negative factors are changing absorption coefficients and gamma buildup.

Absorption coefficients must be representative of the stream makeup. This calculation may be made using known coefficients and must be used to compensate for the changing hydrogen component of an aqueous based slurry with varying solids content.

The gamma buildup issue presents a much more difficult problem. The problem arises because not all gamma photon-matter interactions result in a complete absorption. Many will scatter or deflect into the detector face and do so at a lower energy. These lower energy photons are detected by non-energy discriminate detectors and result in a detected intensity that is many times higher than is predicted by the fundamental absorption laws. As a consequence, the calibration curves of any nuclear density meter that has not been compensated for this extra measured radiation intensity will be in error.

In one embodiment, the method comprises the step of compensating for the gamma scatter by inserting a gamma buildup correction factor into the calibration curve. Gamma buildup and consequently buildup factors are very much dependent on the geometry of the installation. Pipe diameters and wall thickness for example greatly influence photon scatter. These correction factors may be empirically derived and take into account the negative geometric influences.

Therefore, in one aspect, the invention may comprise a method of calibrating a nuclear density meter used in the measurement of density of a sand/water/oil slurry, without sampling the slurry, comprising the steps of:

(a) determining a net attenuation coefficient for the slurry being measured; and

(b) mitigating radiation buildup by taking one or more of the following steps:
i. physically preventing scattered radiation from reaching a detector;
ii. providing an energy sensitive detector and measuring only higher energy non-scattered photons; or
iii. modifying a calibration curve by applying a correction factor to a basic attenuation equation to account for the increase in radiation reaching the detector, wherein the correction factor is determined empirically.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 shows a graph illustrating errors with conventional on-line density measurements.

FIG. 2 shows a schematic nuclear density sensor arrangement.

FIG. 3A shows a schematic representation of gamma rays not originally directed at the detector can be scattered and directed into the detector where they will be detected. These rays are not accounted for by the fundamental attenuation equation. FIG. 3B shows a schematic representation of rays which are scattered out of the beam directed to the detector can be re-scattered back into the detector. Rays of this type lead to “build-up” of the gamma energy detected.

FIG. 4 shows a graph demonstrating that the gamma attenuation coefficient varies both with energy and element.

FIG. 5 shows a graph showing that the attenuation coefficient is a function of the slurry composition, particularly the solids fraction.

FIG. 6 is a schematic representation of potential pathways gamma photons can take between the source and detector.

FIG. 7 is a schematic representation of collimators inserted to prevent scattered off-axis photons from reaching the detector.

FIG. 8 shows output from a multi-channel analyzer/sodium iodide scintillation crystal.

FIG. 9 is a graph showing effect of changing attenuation coefficient (μ) and buildup factor (δ).

FIG. 10 is a graph showing the error incurred if calibration is attempted from first principles and buildup in the system is not included in the model.

FIG. 11 is a schematic representation of a test apparatus setup.

FIG. 12 is a graph showing relative gamma intensity can be derived from MCA histogram.

FIG. 13 is a graph showing density estimates (from measured intensities and eqn. 4) plotted against the true measured densities for the three solutions.

FIG. 14 is a graph showing density estimates using the total counts from the MCA plotted against the true measured densities.

FIG. 15 is a graph showing MCA energy spectra of a 29 cm barrel of salt solution showing the effect of simulating 1″ (2.5 cm) pipe walls using steel plate.

FIG. 16 is a graph showing the same data used in FIG. 15 but the count rates have been normalized at the photopeak.

FIG. 17 is a graph showing the value of ln (Iw/Is) plotted for the 1.5 s.g. salt solution with and without pipe walls.

FIG. 18 shows the required buildup correction varies as the wall thickness changes.

FIG. 19 shows the build-up correction for three different detection techniques: photopeak counts, total counts and a commercial (Berthold) system that counts some smaller set of total counts.

FIG. 20 shows the build up correction (cm) using Equation 4(A), and the build up factor (ϕ) using Equation 4(B), as a function of pipe diameter

FIG. 21A and FIG. 21B show two graphs which demonstrate a non-collimated detector allows considerably more radiation to fall on the detector.

FIG. 22 shows a graph, similar to FIG. 17, where the value of ln (Iw/Is) is plotted for the 1.5 SG salt solution, this time, with and without collimation on the detector.

FIG. 23 is a graph comparing 1″ collimation and 2″ collimation.

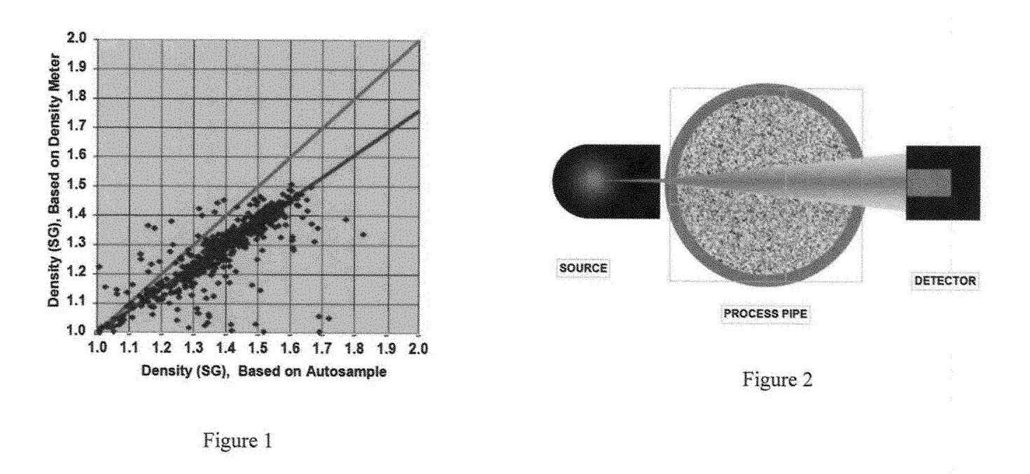

### DETAILED DESCRIPTION

In this description, certain terms have the meanings provided. All other terms and phrases used in this specification have their ordinary meanings as one of skilled in the art would understand. Such ordinary meanings may be obtained by reference to technical dictionaries, well-known to those skilled in the art.

Measuring fluid density in a process pipe by nuclear absorption is a well-known process. A beam of energetic gamma photons from a radioactive isotope source is directed through a cross-section of the pipe (either along the diameter or a chord) and the energy of the beam exiting the other side is measured, as is shown schematically in FIG. 2. The amount of detected energy is a function of the mass between the source and detector, so, as the process stream changes, its density can be determined from a gamma energy measurement.

Gamma photons passing through the material are occasionally scattered out of the beam by interaction with the tightly bound electrons of the material's atoms and the beam is gradually attenuated as it passes through the fluid. The scattering is related to the number and size of the atoms and thus is related to both the density of the material and its atomic composition. The attenuation is characterized by the “mass attenuation coefficient” which is different for each material and varies with the energy of the gamma photons.

The intensity of the exiting beam is given by the following:

I=I₀e^{-μρt} (1)

Where I₀ is the intensity measured at the detector when the pipe is empty, I is the intensity after the pipe is filled with fluid, μ is the mass absorption (attenuation) coefficient (cm2/g) for the fluid, ρ is the slurry density (g/cm3), and t is the distance across the slurry (usually the pipe ID) (cm).

In a density measurement application, it can be assumed that the value I₀ accounts for attenuation of the beam caused by pipe walls, source holder, insulation, or any material other than the process flow, through which the radiation beam passes.

In practice, the measurement of I₀ is always relative to a reference; usually a pipe filled with water. When water is measured, the equation is:

I_{w}=I₀e^{-μ}^{_{w}}^{ρ}^{_{w}}^{t}^{_{w}} (2)

The value of I_{w} is stored and the water replaced by slurry; the measurement is repeated to give:

Iₛ=I₀e^{-μ}^{ₛ}^{ρ}^{ₛ}^{t}^{ₛ} (3)

where μs, ρs, and ts now refer to the slurry. The attenuation coefficient for slurry, μs, will vary with its composition.

To determine the value of ρs, the slurry density, the ratio of equations (2) and (2a) provides:

$$\frac{{I}_{w}}{{I}_{s}} = \frac{{I}_{o} {e}^{- {μ}_{w} {ρ}_{w} {t}_{w}}}{{I}_{o} {e}^{- {μ}_{s} {ρ}_{s} {t}_{s}}} = \frac{{e}^{- {μ}_{w} {ρ}_{w} {t}_{w}}}{{e}^{- {μ}_{s} {ρ}_{s} {t}_{s}}} = {e}^{- {μ}_{w} {ρ}_{w} {t}_{w} + {μ}_{s} {ρ}_{s} {t}_{s}}$$

Taking the natural logarithm and re-arranging results in:

$$ln ( {I}_{w} ) - ln ( {I}_{s} ) = - {μ}_{w} {ρ}_{w} {t}_{w} + {μ}_{s} {ρ}_{s} {t}_{s}$$

$$and$$

$${ρ}_{s} = \frac{{μ}_{w} {ρ}_{w} {t}_{w}}{{μ}_{s} {t}_{s}} + \frac{1}{{μ}_{s} {t}_{s}} ( ln ( {I}_{w} ) - ln ( {I}_{s} ) )$$

Since the pipe diameter is the same, tw=ts, this may be rearranged as:

$${ρ}_{s} = \frac{{μ}_{w}}{{μ}_{s}} {ρ}_{w} + \frac{1}{{μ}_{s} {t}_{s}} ( ln ( {I}_{w} ) - ln ( {I}_{s} ) ) \qquad ( 3 A )$$

and the density can be determined. This equation is often written in the form:

ρₛ=Bρ_{w}+C(ln(I_{w})−ln(Iₛ)) (3B)

When representative samples of the stream are available, the constants B and C can empirically be determined by comparing the detector signal (I) with the density of the samples. It is not necessary to know the precise values for μ or t. In many industrial applications, samples of the fluid can be taken and the above constants easily adjusted in order to calibrate the measurement system. However, it is not feasible to obtain representative sample of a stream of a sand slurry flowing in a large diameter pipe. Therefore, the calibration methods of the present invention may be required.

When samples are not available, the attenuation equation can still be applied, but there are some additional factors need to be taken into consideration. Values of the attenuation coefficients, μx, must be known. The attenuation coefficient varies with both the energy of the gamma radiation employed and the atomic weight of the slurry constituents. The values are well known and tabulated and, though they change with the makeup or solids content of the slurry, the net coefficient for mixtures can be readily calculated.

The proportions of water, sand, clay, and bitumen all vary with the solids content of a slurry. Since each of these components has a different attenuation, the average attenuation coefficient of the mixture will also vary. The overall absorbance coefficient, μ, can readily be calculated if the composition of the slurry is known.

$$μ = {\sum }_{i} {w}_{i} {μ}_{i}$$

where wi is the fraction by weight of the i^{th} atomic constituent and the μi are the coefficients for each element. The coefficients are calculated to high precision and tables of values are readily available. The mass attenuation coefficient is referred to as μ. The μ values for the predominant elements in a clay-and slurry are given in the table below.

| | μ (cm²/g) |
|---|---|
| | (for gammas with energy of |
| Element | 0.662 MeV) |
| Hydrogen | 0.1544 |
| Oxygen | 0.0774 |
| Silicon | 0.0775 |
| Aluminum | 0.0748 |
| Potassium | 0/0759 |
| Iron | 0.0737 |
| Magnesium | 0.0766 |
| Water | 0.0859 |

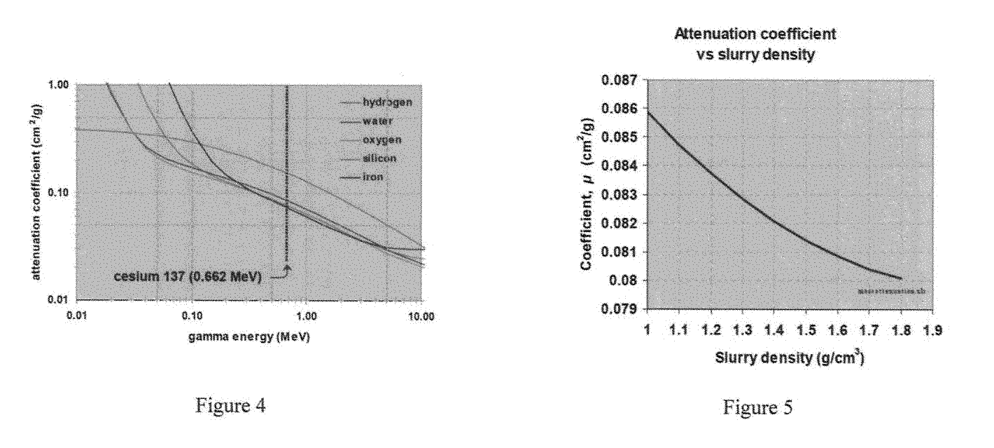

At the gamma energy of 0.662 MeV, most elements have about the same coefficient. Hydrogen is anomalous, with an attenuation coefficient about two times the others (see FIG. 4). At the energy of cesium 137, the coefficient for most elements is about the same. A notable exception is hydrogen, which is about 2 times as great. Since water is the main constituent of bitumen slurries, the overall coefficient varies with the slurry composition. Since water contains 11 wt % hydrogen, it has a higher effective attenuation; a fact that is very important in aqueous slurries since the proportion of water changes with density.

The effective μ for aqueous sand/clay slurries is shown in FIG. 5. These values were obtained by calculating the effect of various elements at various concentrations as density is varied. The attenuation coefficient is a function of the slurry composition, particularity the fraction solids. This is because the elements making up the solids have a coefficient, which is quite different from water. Since the coefficient varies with solids, it will then be a function of density. With no solids, the slurry will have the same density as water and the same coefficient. As solids increase the slurry coefficient will decrease as the graph in FIG. 5 shows.

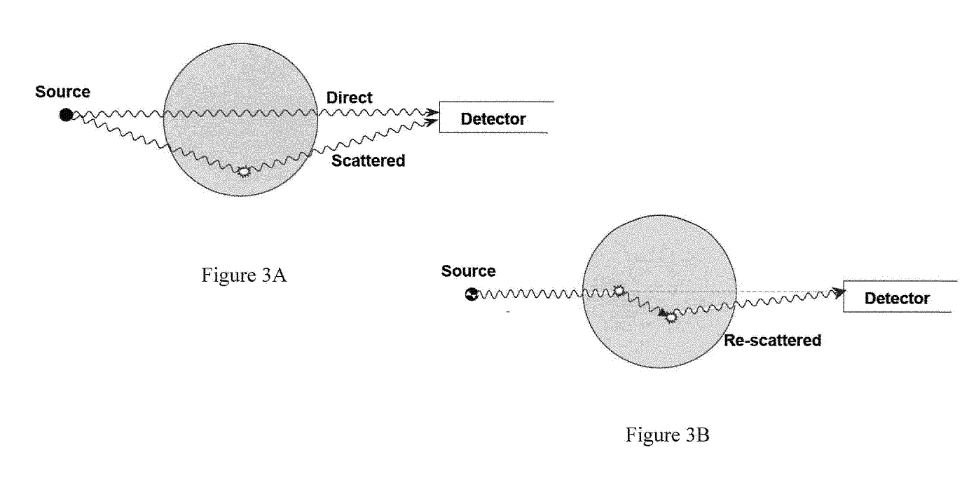

Equation (1) describes only the attenuation of the gamma beam as it passes through the liquid. In addition to the radiation of the unattenuated portion of the beam, additional radiation also falls on the detector. A phenomenon called radiation “build-up” can greatly increase the radiation reaching the detector. Build-up occurs when gamma rays that are not originally directed at the detector, are scattered and redirected into the detector, as shown schematically in FIG. 3a. Also, when gamma radiation is scattered out of the original well-directed beam, it can interact again with the fluid and be re-scattered. It loses some energy in scattering and if the absorber is large enough, the deflected gamma will be scattered again, and again until all its energy is absorbed. However, some of these gamma photons leave the absorber after one or more scatterings and depending on the geometry can reach the detector, as shown in FIG. 3b. The total amount of energy falling on the detector can be several times greater than that of the unattenuated beam strength predicted by equation (1). Since only the unattenuated portion of the beam can be accurately described by equation (1), it is desirable to prevent the scattered radiation from reaching the detector or otherwise accounting for the scattered radiation. Then the known values for absorption coefficients can be used with confidence and no sampling will be required.

There are three main ways of accounting for this build-up:

1. Prevent the scattered radiation from reaching the detector. This is accomplished by using collimation on the source and detector to limit the beam to what is called the “narrow beam geometry”. The collimation prevents the scattered and re-scattered radiation from reaching the detector.

2. Use an energy sensitive detector. Since scattered gamma photons have lost some of their energy, the use of an energy sensitive detector, such as a sodium iodide (NaI) scintillation crystal coupled with a multi-channel analyzer (MCA), allows the unattenuated gamma photons, those predicted by equation (1), to be distinguished from the lower-energy scattered photons. Only the high-energy photons that have not been scattered are counted; the rest are ignored.

3. Account for the extra radiation. Various attempts have applied different empirical corrections to the basic attenuation equation to account for the increase in radiation reaching the detector.

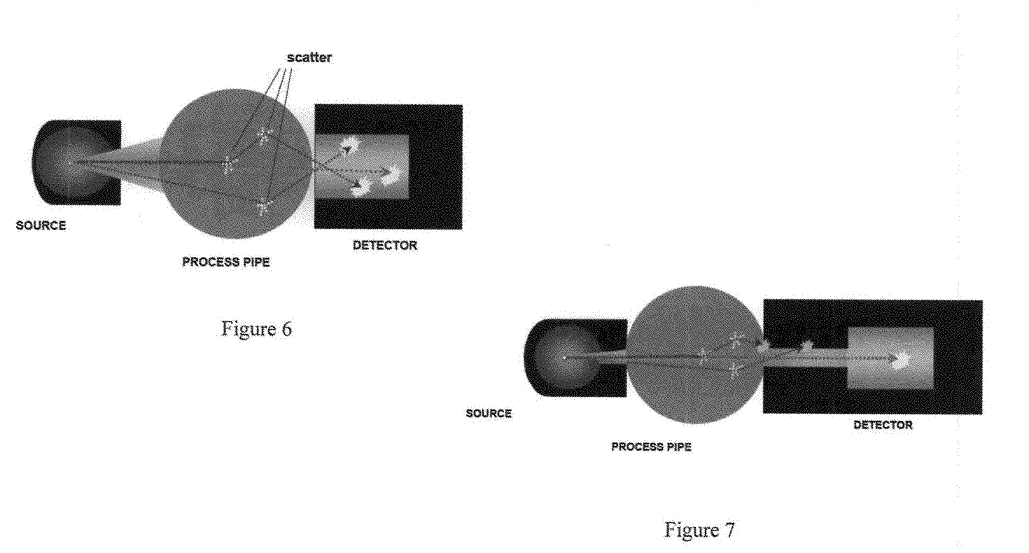

FIG. 6 shows schematically how radiation from the source interacting with any material in the region can be scattered at an angle, which will deflect it into the detector. Only the unscattered radiation can be accurately described mathematically; that which takes the red dashed path. A large number of off-axis photons which have been scattered by the slurry and pipes can also reach the detector. In practice, the number of scattered gamma photons reaching the detector will outnumber the photons in the main beam by a factor of 5 to 10. These scattered photons are difficult to describe in a model.

In FIG. 7, a collimator of high-density material is shown to attenuate scattered radiation while allowing the non-scattered radiation beam to reach the detector. Collimation will substantially reduce the number of scattered photons reaching the detector. A collimator may be provide at both the source and detector sides, however, in practice often only the collimator at the detector side is needed.

Gamma photons which have interacted with atoms of the fluid and been scattered out of the main beam can subsequently interact with other atoms and be scattered in the direction of the detector. These scattered photons will have lost some energy because of the interactions and will arrive at the detector with a lower energy than photons that have passed through the fluid without interacting.

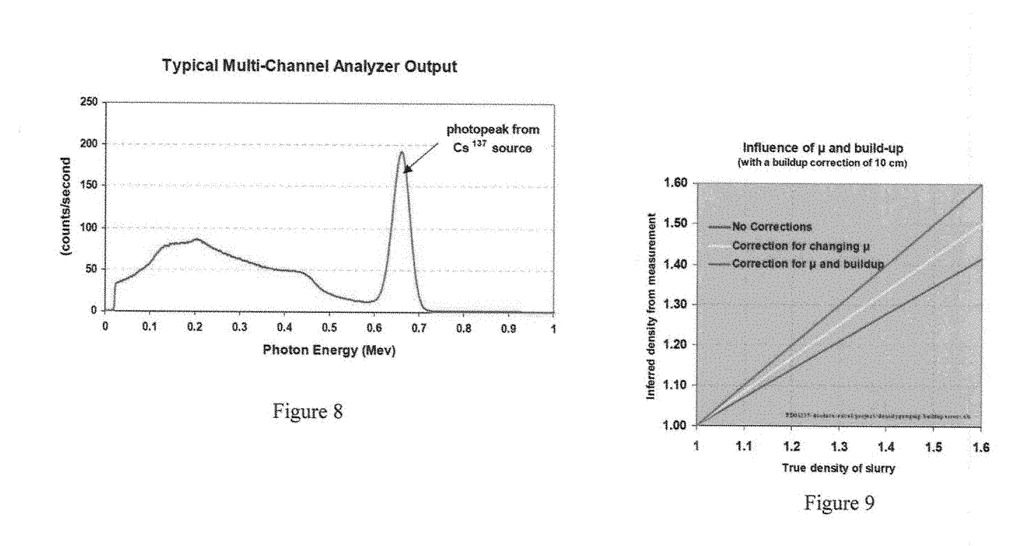

In an alternative embodiment, a detection system capable of measuring the energy of individual photons can be used to distinguish between the scattered photons and those of the main beam. A sodium iodide (NaI) scintillation crystal coupled to a compact multi-channel analyzer (MCA) was used for this investigation. FIG. 8 shows an example of the output from this system. The output of the MCA is a histogram of the number photons received as a function of the energy of each photon detected. The peak on the right is produced by high energy gamma photons which enter the crystal from the source without having undergone any scattering interactions. The count rates at lower energies are from photons from the same source (same initial energy) but now have less energy from having been scattered.

This combination measures the number of gamma photons at each energy and presents the information as a histogram. In this example, gamma photons from a radioactive Cesium 137 source are being detected. Photons which have lost energy via scattering show as lower energy. Cesium 137 (a common source for density measurement applications) produces a gamma photon with energy of 0.662 MeV (million electron volts). These photons are responsible for the photopeak on the right in FIG. 8. If only those photons received with the photopeak energy are counted and the rest ignored, then the conditions to accurately use equations (1) and (3) along with known attenuation coefficients are satisfied to estimate the density.

In an alternative embodiment, the extra energy may be accounted for by simply including a multiplying “buildup factor” in the basic equation:

I=B_{f}I₀e^{-μρt}

The buildup factor Bf is greater than 1 and can be as high as 10. The factor is related to the material of the absorber and may be expressed in different ways [4,5,6]. In one example, it may be expressed as:

B_{f}=e^{-μρδ}

Buildup will increase with μ and ρ. In this form, the effect of buildup can be thought of as modifying the path length. That is, we will artificially reduce the path length t by an amount δ the equation may be written as:

I=I₀e^{-μρ(t-δ)}

This gives an “effective path length” which is less than the actual path length. Extra radiation from buildup effects will lead to greater signal intensity at the detector, thus simulating the effect of a shorter path length. Equipped with this expression of the attenuation equation, density can be estimated directly from a measurement of I, provided δ is known. Equation 3 (above) may be modified, including δ to get:

$$\begin{matrix}{ρ}_{s} = \frac{{μ}_{w} {ρ}_{w}}{{μ}_{s}} + \frac{1}{{μ}_{s} ( t - δ )} ( ln ( {I}_{w} ) - ln ( {I}_{s} ) ) \\ or & ( 4 ) \\ {ρ}_{s} = \frac{{μ}_{w} {ρ}_{w}}{{μ}_{s}} + \frac{1}{{μ}_{s} ( t - δ )} ln ( \frac{{I}_{w}}{{I}_{s}} ) & ( 4 A ) \\ {ρ}_{s} = \frac{{μ}_{w} {ρ}_{w}}{{μ}_{s}} + \frac{1}{{Φμ}_{s} t} ln ( \frac{{I}_{w}}{{I}_{s}} ) & ( 4 B )\end{matrix}$$

In arriving at this equation, we assume that the buildup correction, δ, is the same for water and slurry. If δ is small compared to t, its inclusion will have a small effect. If it is significant but can be estimated reasonably well, its effect, and the measurement error due to buildup, will be minimized (see FIG. 9).

In a conventional nuclear density gauge installation, the instrument should be calibrated with at least two materials of known density. In slurry applications, these are usually water and a slurry of accurately known (by sampling) density. Often several slurry samples are taken and averages used. Alternatively, the manufacturer will calibrate the instrument based on some model of how the instrument will respond. The accuracy of this calibration depends on the accuracy of the manufacturer's model.

In one embodiment of the present invention, the sampling requirement is eliminated by using a model based on equation (4), which is taken to describe the response of the instrument with sufficient accuracy.

If it is assumed that all materials have the same absorption coefficient and there is no buildup phenomenon, a form of equation (1) would be used, however, the resulting calibration would result in the instrument reading low, as shown in FIG. 9 (no correction line—an error of about 10% at an specific gravity of 1.5.). If the equation we use to calibrate the instrument includes a correction for the changing μ value, the calibration would result in readings that are better, but still low (middle line—an error of about 5%). If both the correct μ and the effect of buildup, δ, are accounted in the equation, the instrument reading will approach the true density value (top line).

Unlike μ, the buildup coefficient cannot be readily calculated. However, since it is expected to be strongly influenced by geometry and the detection system, it was felt that it could be measured for various geometries and its value approximated for real applications with similar geometries to those tested.

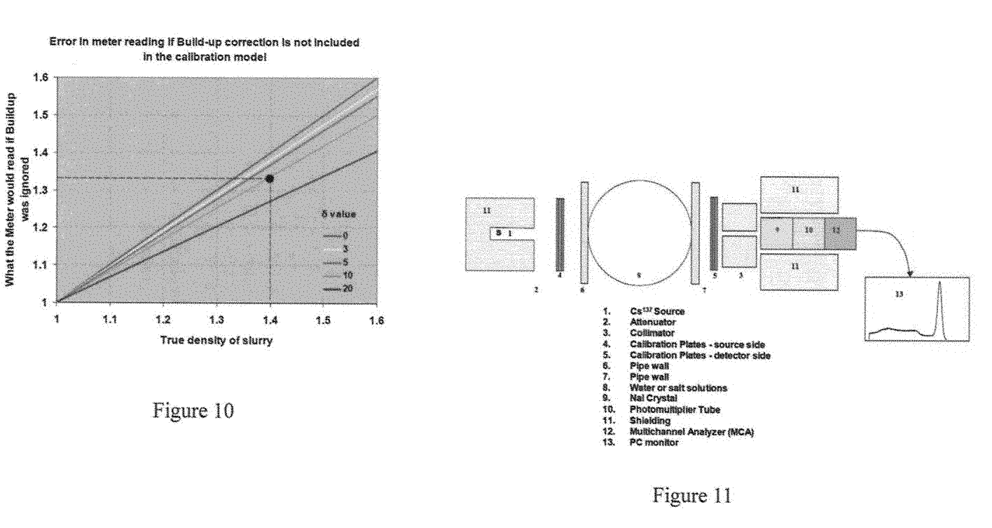

FIG. 10 shows the error, which could be made by using a model, which does not include a buildup factor. The error is greater if the buildup for a particular system is larger. If there is no buildup, as in a narrow beam geometry, the meter reading will be accurate even if the model does not include buildup effects. If the buildup effect is as great as 20, then the meter error will be quite large when the effect of buildup is ignored in the model. For example if the true specific gravity is 1.4 and the buildup in the system has a value of 10, then meter will read 1.34 if this buildup number has been ignored. If the measurement geometry can be modified so that the buildup is small, then the error incurred will be much smaller even if only an approximate estimate of δ delta is used in the model. For example; if the buildup can be reduced to 3, then the error in specific gravity will be less than 0.02 even if the buildup is ignored.

### EXAMPLES

Examples are provided which demonstrate the feasibility of using a simple model for gamma attenuation (as expressed by equation 4) to relate a gamma measurement to the specific gravity of a slurry without the need for empirical calibration. The effect of variable attenuation coefficients, discussed above can be calculated and readily included in the model. Examples aimed at exploring the extent of radiation buildup and the feasibility of specifying values for buildup factors to be included in the model.

### Experimental Set-Up

The test equipment is shown schematically in FIG. 11. The equipment had the following features:
1. Slurry was simulated using water and salt solutions (specific gravities of 1, 1.37, 1.5 and 1.7).
2. Steel plates were used to simulate the pipe walls.
3. A 180 millicurie Cesium 137 source was used.
4. A 2″×2″ NaI scintillation crystal was used in conjunction with a compact 1028 channel multichannel analyzer.
5. Various absorption plates of tungsten and steel were available.
6. Steel collimators of various diameters from 0.25 to 2″.

The tests were determined using salt solutions which is believed to accurately simulate the results expected from slurries. Several samples of each salt solution were taken and specific gravity determined. The attenuation factor for each solution was calculated using the known elemental composition and the salt concentration.

| | Specific gravity | | Attenuation |
|---|---|---|---|
| | (as specified by | Specific gravity | coefficient |
| Solution | supplier) | (as measured) | (cm2/g) |
| water | 1.0 | | 0.0859 |
| 38 wt % CaCl | 1.37 | 1.354 | 0.0821 |
| 42 wt % CaBr₂ | 1.5 | 1.485 | 0.0804 |
| 52 wt % CaBr₂ | 1.7 | 1.712 | 0.0791 |

The source size of about 180 millicuries was about 5 to 10% of the size normally used for large slurry line applications. Because of the smaller source size, longer radiation count times were required to provide an accurate measure of the radiation signal. The counting time for each test was typically 300 seconds. Personnel were shielded from the source by sand bags and a specific area flagged off for entry by authorized personnel only.

The detector was a 2″×2″ NaI scintillation crystal. The photomultiplier was directly coupled to a miniature multichannel analyzer (MCA) which in turn was connected via a USB connection to a computer. The detector was shielded with steel plates from background radiation; this shielding reduced the background to a negligible level. A detector of the type used with commercial density measurement system (Berthold Technologies) was also used in some tests.

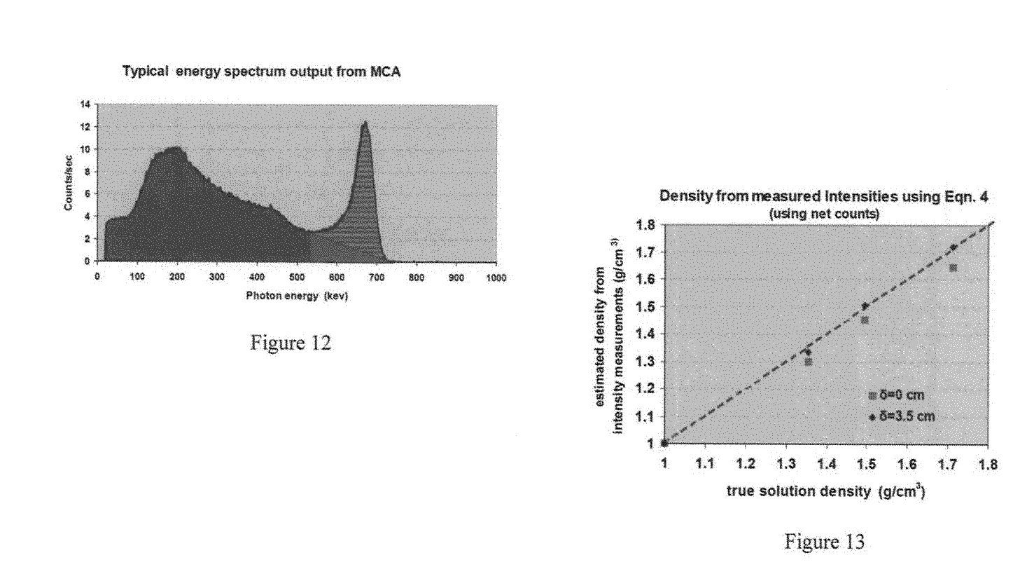

A series of test was performed using 29.2 cm (11.5″) barrels with water and three salt solutions with specific gravities of 1.35, 1.5 and 1.7. Measurements were performed with and without collimation. The collimator was a 1″ diameter hole in heavy steel plate three inches thick and was placed next to the detector. Readings were also taken with the collimator placed next to the source. The signal from the MCA detector is treated in three ways (FIG. 12).
a) The total count at all energies. This reports all the gamma photons detected at any energy; this includes the photons which pass through the fluid and pipe without interacting (those described by equation 1) as well as those scattered within the fluid and pipe walls but still reaching the detector (those photons responsible for the buildup). The total count will simulate the behaviour of a detector without energy discrimination ability and mimics the response of the detectors in most commercial density instruments. This is the simplest measurement for an instrument manufacturer to supply; all the gamma pulses are counted regardless of energy.
b) The gross counts within the photopeak. This reports all the photons within the energy of the photo peak (the photons which have passed through without interaction) as well as photons from the natural background radiation. As far as the instrument is concerned, only pulses above a certain energy need to be counted; this is also relatively simple to achieve.
c) The net counts in the photo peak. The value for net counts is derived from the gross counts by subtracting the baseline interpolated through the photopeak. This is intended to eliminate any background effects. To measure the net counts in the photopeak, a full multichannel analyzer is required to provide the entire spectrum.
   FIG. 12 shows the relative gamma intensity can be derived from MCA histogram signal in several ways. a) the area under the full peak histogram b) the area under the photopeak or c) the area under the photopeak with the extrapolated baseline removed (cross-hatched area)

For each set of measurements, the collimators and shields were put in place and a barrel of room temperature water was positioned in the path of the beam. The shutter was opened and the MCA allowed to collect information for 300 seconds; the total count was stored and used as the water reference measurement.

This barrel of water was replaced with a barrel of salt solution and the measurement repeated. Each of the salt mixtures was measured in the same manner. A typical test result would be as follows: Conditions

Simulated slurry pipe ID 29.21 cm (11.5″)

Simulated pipe walls 1″ steel

Collimation diameter 1″ (detector side only)

| | | Total | Gross Peak | Net Peak |
|---|---|---|---|---|
| | Atten. Coeff. | counts | Counts | Counts |
| Pipe contents | (calculated) | (300)sec | (300)sec | (300)sec |
| 1.0 SG water | 0.0859 cm2/g | 195234 | 46368 | 32874 |
| 1.35 SG. sol'n | 0.0821 | 118980 | 25422 | 17895 |
| 1.5 SG. sol'n | 0.0804 | 97591 | 19932 | 13341 |
| 1.7 SG sol'n | 0.0791 | 72920 | 14247 | 9096 |

Recalling Equation 4, developed earlier, and the detector outputs, I, for water and the salt solutions, the density estimated from the modeled response of the system is calculated:

$${ρ}_{s} = \frac{{μ}_{w} {ρ}_{w}}{{μ}_{s}} + \frac{1}{{μ}_{s} ( t - δ )} ln ( \frac{{I}_{w}}{{I}_{s}} )$$

The values estimated above were then compared to the actual density of the salt solution as determined gravimetrically. The value of δ which gives use the best match is then assumed to be the correct buildup correction for the particular geometry used. FIG. 13 shows the density estimates (from measured intensities and eqn. 4) plotted against the true measured densities for the three solutions. With buildup correction applied, the error is estimated to be about 0.5 g/cm3 at 1.5. The correction parameter δ is adjusted to minimize the error. In this case, δ≈3.5 cm. (The dotted line depicts a best match).

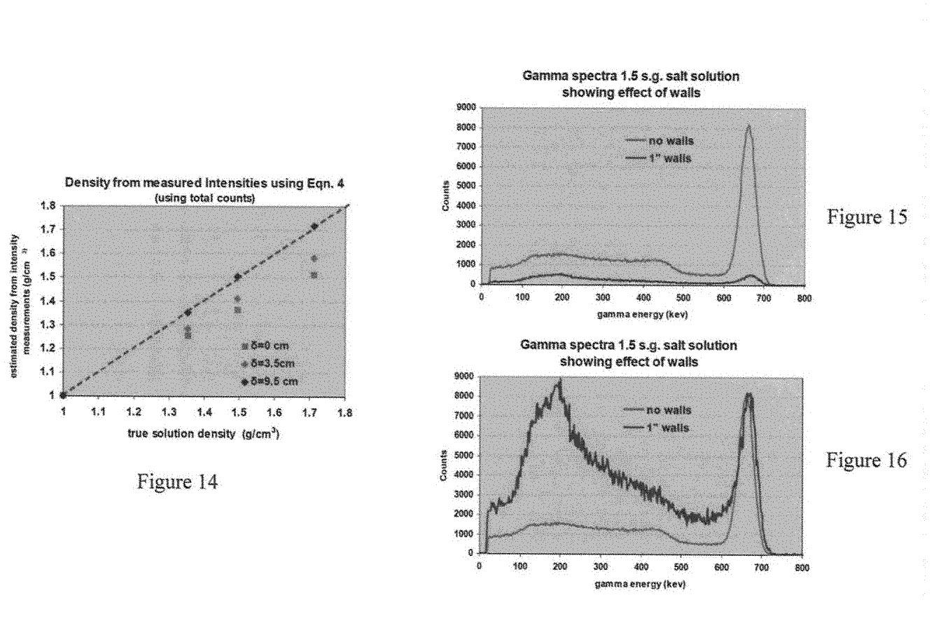

Total count rates from the detector (rather than just the photopeak counts) were used in the calculation, and the results shown in FIG. 14. In this case, a much larger buildup factor is required in the model. This is much as expected, since from the total gamma count includes more scattered radiation than does the peak count. With no buildup accounted for, the error is about 0.15 at a value of 1.5. If the same correction as the previous case is used, there is still a large error. In order to minimize the error, a buildup of δ≈9.5 cm is required.

### Effect of Pipe Walls

The wall of the pipe has a large influence on the transmission of gamma energy through the measurement system. FIG. 15 shows the MCA output for a 29 cm diameter thin walled barrel along with the same barrel with 1″ thick steel walls (simulated with plates). The steel pipe wall reduces the transmitted energy by about 95%. This is the main reason frequent standardization of a density meter is very important; if the pipe wall wears by 1 millimeter, the radiation at the detector in this example will increase by 10% and the estimate of slurry density will change by 3%. Frequent standardization (referencing the system with water) will largely eliminate this error. FIG. 15 shows the MCA energy spectra of a 29 cm barrel of salt solution showing the effect of simulating 1″ (2.5 cm) pipe walls using steel plate. Thick pipe walls reduce the energy reaching the detector by about 90%.

The wall will also have an effect on the scattered gamma energy. The wall will scatter many more photons than the slurry; some of these will reach the detector at lower energy than the photopeak. The effect of the wall next to the detector will have the greater effect, merely because of geometry. As long as the proportion of this extra scattered energy stays the same for the water reference and the slurry measurement, there will be no error because of it. However, this proportion does not remain constant, requiring a buildup correction that depends on wall thickness.

FIG. 16 uses the same data used in FIG. 15 but the count rates have been normalized at the photopeak. The proportion of lower-energy, scattered radiation (relative to the photopeak energy) is much higher for the 1″ pipe wall case.

Again looking at the basic equation, in

ln(I_{w}/Iₛ)=(μₛρₛ−μ_{w}ρ_{w})(t−δ),

it is noted that in a given situation with values for μw, μs, ρw, ρs, and δ, that the value of ln (Iw/Is) should be fixed. However, scattered gammas have a slightly different path lengths and lower energy (leading to different values for μ, as in FIG. 4), and the term ln (Iw/Is) should reflect this.

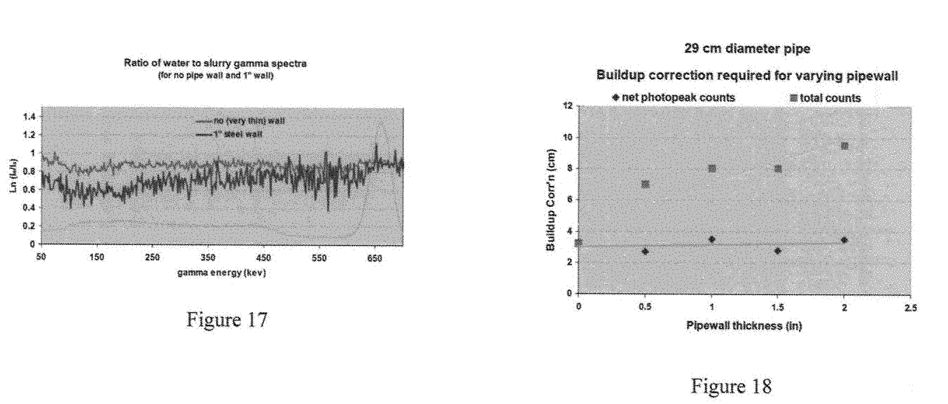

In FIG. 17, the measured values of ln (Iw/Is) are plotted as a function of energy. Three observations can be made:
1. the value of ln (Iw/Is) varies with energy, as expected,
2. the variation is different depending on the wall thickness of the pipe (0″ or 1″), and
3. at the photopeak, the value is about the same. At lower values there is significant difference.
   Accordingly, if only the information at the photopeak energy is used, a wide range of conditions can be described with the same model. If information from lower energies is included as well, then the model must be tailored for different conditions (in the example, for different pipe wall thicknesses).

In practice, using an MCA gives the option of using only the counts within the photopeak. FIG. 18 shows that this would allow the two cases here (different wall thicknesses) to be treated in exactly the same way. If total counts were used, then the two cases would need to be treated differently, for example by ascribing a different buildup factor which would be a function of wall thickness. FIG. 18 shows that the required buildup correction varies as the wall thickness changes. This would be expected since more attenuation in the path increases the opportunity for scattered rays finding a path to the detector. It is difficult to avoid measuring all the scattered radiation, but by limiting the detection to the photopeak net counts alone (blue points) the buildup correction is about 3 cm, independent of wall thickness, If the total signal is used, the correction is larger and more variable.

Comparing this figure with FIG. 10 which shows the error due to improperly selecting the buildup correction, we see that the use of the photopeak signal can significantly reduce the potential for error. A similar series of measurements was carried out using a 55 cm drum to simulate a larger line. For these tests, a gamma detection system from a manufacturer (Berthold) of commercial density gauges was available. While this instrument also used a NaI scintillation detector, it was not possible to ascertain the signal analysis method used, but it was not an MCA. The intensities measured were over a range of energies but the limits of the range are not known.

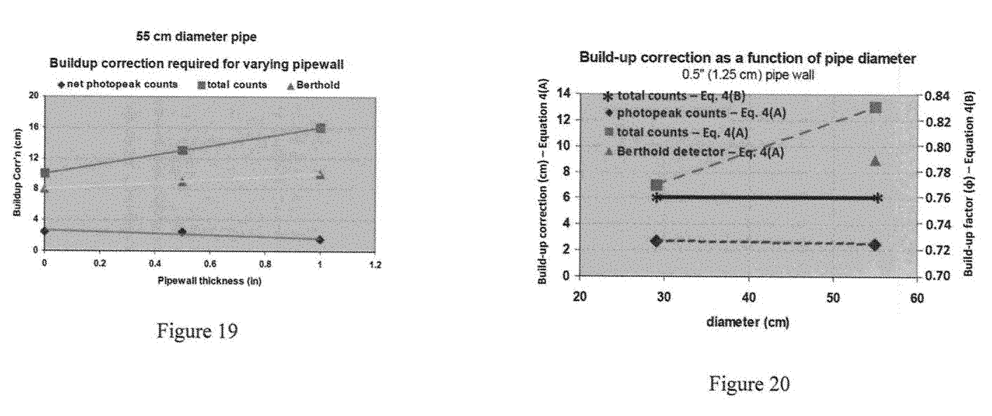

FIG. 19 shows the results. Several pipe wall thickness were again simulated and the buildup correction which best match the true density of the test solutions was determined. The results are similar to those for the 29 cm drum. The buildup correction when the count rate in the net photopeak was used is again reasonably constant and only a small error would be incurred by using the same value for all conditions; a value of about 3 cm would be appropriate for both drum diameter and any of the wall thickness measured.

The buildup correction was considerably higher (compared to the 29 cm drum) for the total count rate measure. This could be expected with a larger diameter. The results for the Berthold detector were intermediate between the net peak and the total peak results. This suggests that the Berthold ignores some of the lower energy pulse when taking the count rate measurement. (This is commonly done in pulse counting electronics).

### Effect of Pipe Diameter

The above data was plotted to show the effect of pipe diameter and shown in FIG. 20. Although we have results for only 29 cm and 55 cm pipe diameters, these show a large effect. If total counts are used, the buildup correction must be varied from 7 cm for the smaller diameter to 13 for the larger. If only photopeak counts are used, a factor of about 3 cm will suffice for both diameters. Only 55 cm data was available for the commercial detector.

The results show a definite advantage in using only the photopeak. With the photopeak, the buildup factor is almost the same even though the diameter is doubled. If total counts are used, a separate factor for each case must be determined. (Here a linear variation of the correction factor with diameter is shown, but no data was collected to support this.)

The commercial detector appears to respond midway between a total count device and a photopeak counting device.

### Effect of Collimation

From the previous discussions, the collimation of the gamma beam should have a large influence on the findings. FIG. 20 shows data for a case where there was no collimation of the NaI detector (2″×2″×2″ cube) and where a collimator, 1″ diameter and 3″ in length, was placed in front of the detector. These measurements were taken with the 1.5 SG solution in 29 cm drum.

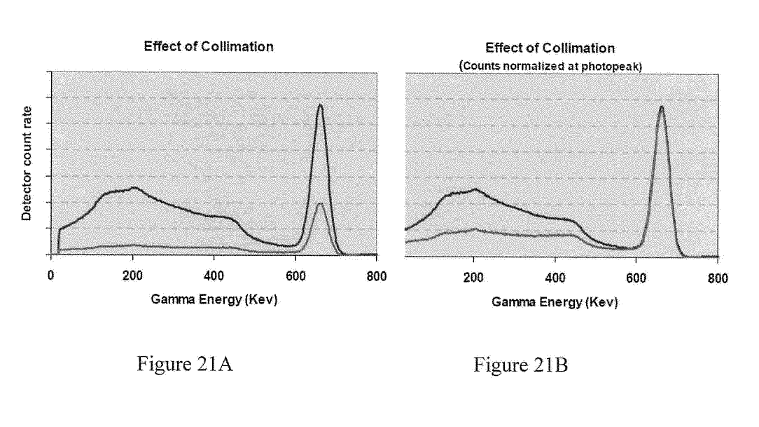

The most obvious effect of collimation is the reduction of the signal. The total count rate (total area) is reduced by a factor of almost five. The photopeak count rate is reduced by a factor of three. The immediate consequence of this is that if a collimator is used, a larger source size is required to provide the same count rate as an non-collimated detector. As shown in FIG. 21, a non-collimated detector allows considerably more radiation to fall on the detector. This reduces the source size for a given count rate, but significantly increases the amount of scattered radiation hitting the detector. On the right, the two spectra have been normalized to show how much this proportion between the photopeak and total counts has changed. When we examine the scattered gamma radiation, we see that the collimator does, as expected, reduce the amount of scattered radiation considerably. FIG. 21 compares the two cases (after normalization) and we see that the scattered radiation is almost completely eliminated. Most of the remaining low energy counted is the result of scattering within the NaI crystal itself and is the result of 662 keV gammas which have reached the crystal without being scattered.

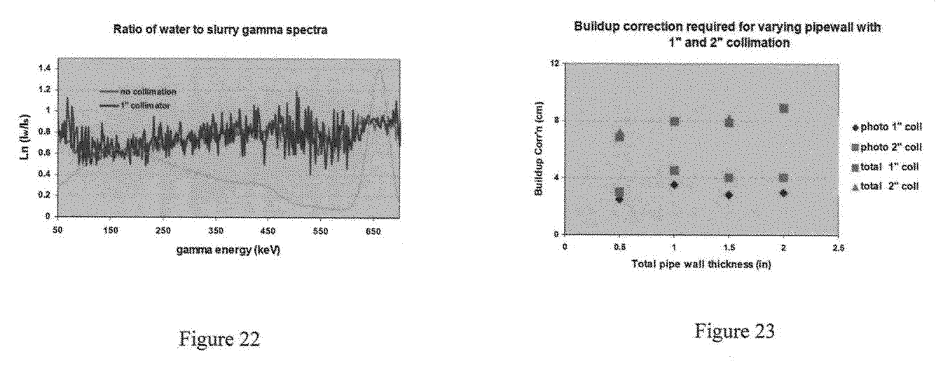

The term ln (Iw/Is) was calculated and its value compared across the energy spectrum (FIG. 22) this time, with and without collimation on the detector. In this case the term takes on the same value for each case at any energy. So, while the build-up correction will be different depending on the range of energy used in the calculation, it will be the same for both the collimated and non-collimated cases. This result is a little different. We see that the value changes with energy as a result of buildup, but the ratio at any energy is the same for both cases. The average value for the total counts will be different than for the peak counts, but it will be the same for both the collimated and non-collimated cases. This means a larger buildup correction will be required if the average total counts are used, but the correction factor will not be too sensitive to whether or not the detector is collimated.

1″ and 2″ collimation were compared with the same results: for thick walls the buildup factor needed to be increased significantly when using total counts, but the collimation used made no difference. When using the photopeak counts, the factor was not a function of wall thickness and remained small; collimation had only a small effect (FIG. 23). The buildup correction needs a slight increase from 3 cm to 4 cm. For the total count measurement, even though the buildup correction required was much higher, there was no noticeable difference between the 1″ collimation and 2″ collimation cases. The pipe walls were simulated with combinations of 0.5″ steel and 1″ steel plates with the total thickness shown here.

Conclusions from Testing

Improved performance of nuclear density gauges is possible. This improvement can be achieved at the same time as eliminating sampling for calibration. Preferably collimation is not used alone to eliminate buildup effects on thick-walled pipes. Preferably, frequent standardization (measuring output with water) is desirable to maintain accuracy under any system of calibration. Preferably, superior performance may be achieved with an energy discriminating sensor such as a NaI scintillation crystal in combination with a MCA. This will, however, reduce the count rate considerably and to maintain a sufficiently large signal-to-noise, a larger radiation source may be required. An alternative to a larger source may be to accept a slower response time.

### Definitions and Interpretation

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### REFERENCES

Where permitted, the following references are incorporated herein by reference in their entirety, for all purposes.
1. Neiman, Owen, “2006 Extraction Density Gauge Survey”. (Personal communication)
2. Dougan, P, “Calibrating Nuclear Density Gauges for Slurry Density in Extraction”, Syncrude Canada Ltd. 1982 Research Department. Progress Report, 11 (7) 222-(1982)
3. Dougan, P, “Calibrating Nuclear Density Gauges for Slurry Measurement”, Syncrude Canada Ltd. 1986 Research Department. Progress Report, 15 (7) 250-(1986)
4. McKinney, A. H. and Jones, J. B. “Radiation Measurements for Process Control”. ISA ED 72356, p. 69, Instrument Society of America, 1972.
5. Denning, R. A. “Calibrating Nuclear Gauges for Slurry Density” Control Engineering, p. 79, February 1965.
6. McKinney, A. H. “Radiation Surveys for Process Information. Instrumentation in the Chemical and Petroleum Industries”. Vol. 7, pages 92-114. Instrument Society of America.

1. A method of calibrating a nuclear density meter used in the measurement of density of a sand/water/oil slurry flowing in a pipe, without sampling the slurry, comprising the steps of:
(a) determining a net attenuation coefficient for the slurry being measured; and
(b) mitigating radiation buildup by modifying a calibration curve by applying a correction factor to a basic attenuation equation to account for the increase in radiation reaching the detector, wherein the correction factor is determined empirically.

2. (canceled)

3. (canceled)

4. The method of claim 1 wherein step (b) is implemented by measuring radiation buildup of a pipe having the same diameter and wall thickness as the slurry pipe to determine the correction.

5. The method of claim 4 wherein the correction factor effectively reduces an actual path length to a shorter effective path length.

6. (canceled)

7. The method of claim 2 wherein step (b) is implemented by measuring radiation buildup of a pipe having the same diameter and wall thickness as the slurry pipe to determine the correction.

8. The method of claim 3 wherein step (b) is implemented by measuring radiation buildup of a pipe having the same diameter and wall thickness as the slurry pipe to determine the correction.

9. The method of claim 7 wherein the correction factor effectively reduces an actual path length to a shorter effective path length.

10. The method of claim 8 wherein the correction factor effectively reduces an actual path length to a shorter effective path length.
